(19) United States
(12) Patent Application Publication
(10) Pub. No.: US 2014/0365972 A1
(43) Pub. Date: Dec. 11, 2014

(54) METHOD FOR SELECTING MULTIPLE OBJECTS AND ELECTRONIC DEVICE

(71) Applicant: Acer Incorporated, New Taipei City (TW)

(72) Inventors: Chien-Hung Li, New Taipei City (TW); Chan-Ping Po, New Taipei City (TW); Yueh-Yarng Tsai, New Taipei City (TW); Yu-Hsuan Shen, New Taipei City (TW); Shang-Yi Huang, New Taipei City (TW); Yi-Wen Liu, New Taipei City (TW)

(73) Assignee: Acer Incorporated, New Taipei City (TW)

(21) Appl. No.: 14/190,099

(22) Filed: Feb. 26, 2014

(30) Foreign Application Priority Data
Jun. 5, 2013 (TW) 102119975

(51) Int. Cl. G06F 3/0482; G06F 3/0488

(52) U.S. Cl. CPC G06F 3/0482; G06F 3/0488
USPC 715/840

(57) ABSTRACT

A method for selecting multiple objects and an electronic device are provided, and the method for selecting multiple objects is applicable to the electronic device. The electronic device includes a touch screen and a processor, and the processor executes an operating system (OS). The method includes: identifying whether an application currently executed by the OS belongs to a first type application or a second type application; when the application currently executed by the OS is identified to belong to the first type application, displaying a first multi-selection button by the touch screen, where the first multi-selection button is configured to generate a first button event when the first multi-selection button is triggered ; and when the first button event is detected by the touch screen, activating or deactivating a first multiple objects selection function of the application which is currently executed by the OS.

### CROSS-REFERENCE TO RELATED APPLICATION

This application claims the priority benefit of Taiwan application serial no. 102119975, filed on Jun. 5, 2013. The entirety of the above-mentioned patent application is hereby incorporated by reference herein and made a part of this specification.

### BACKGROUND

1. Field of the Disclosure

The present disclosure generally relates to a computer system, and more particularly, to a method for selecting multiple objects and an electronic device thereof.

2. Description of Related Art

Along with the widespread of tablet computers and smart phones, people are getting used to control the computer system with a direct touch rather than conventional tools such as a mouse or a keyboard. When using Microsoft Windows Operating System on the tablet computer or the smart phone, if the user is intended to activate a function of selecting multiple objects supported by a certain application, the user is required to open the setting menu of the on-screen keyboard, and to set the on-screen keyboard executed under a standard keyboard mode via the setting menu. After the previous setting is completed, the user is still required to call the on-screen keyboard application, and further to press a specific function button or a combination of the function buttons on the displayed on-screen keyboard, so as to activate the function of selecting multiple objects supported by the certain application, or to deactivate the function of selecting multiple objects of the application which has already been activated.

However, the procedure required for activating or deactivating the function of selecting multiple objects of the application via the on-screen keyboard on the touch screen is complex, and the on-screen keyboard displayed on the touch screen usually occupies a lot of space for displaying. As the result, it is inconvenient for the user in applying the function of selecting multiple objects.

### SUMMARY OF THE DISCLOSURE

In view of the aforementioned, the present disclosure provides a method for selecting multiple objects for providing various multi-selection buttons corresponding to various applications, such that the user can activate the multiple objects selection function of the application rapidly.

The present disclosure further provides an electronic device, which simplifies the operation procedure required for activating or deactivating the multiple objects selection function of the application on the touch-controlled electronic device.

The present disclosure provides a method for selecting multiple objects applicable to an electronic device. The electronic device includes a touch screen and a processor, and the processor executes an operating system (OS). The method for selecting multiple objects includes identifying whether an application currently executed by the OS belongs to a first type application or a second type application; when the application currently executed by the OS is identified to belong to the first type application, displaying a first multi-selection button by the touch screen, wherein the first multi-selection button is configured to generate a first button event when the first multi-selection button is triggered; and when the first button event is detected by the touch screen, activating or deactivating a first multiple objects selection function of the application which is currently executed by the OS.

The present disclosure provides an electronic device including a touch screen and a processor. The processor is coupled to the touch screen and executes an operating system. The processor identifies whether an application currently executed by the OS belongs to a first type application or a second type application. When the application currently executed by the OS is identified to belong to the first type application, the touch screen displays a first multi-selection button, wherein the first multi-selection button is configured to generate a first button event when the first multi-selection button is triggered. When the first button event is detected by the touch screen, a first multiple objects selection function of the application currently executed by the OS is activated or deactivated.

As described above, in the present disclosure, one or more specific multi-selection buttons are displayed on the touch screen according to the application currently executed by the OS. When detecting that one of the multi-selection buttons is selected by the user on the touch screen, the present disclosure applies the button event corresponding to the selected multi-selection button to activate or deactivate the multiple objects selection function of the application currently executed by the OS, so as to reach the achievement of simplifying the procedure of activating or deactivating the multiple objects selection function of the application.

These and other exemplary embodiments, features, aspects, and advantages of the disclosure will be described and become more apparent from the detailed description of exemplary embodiments when read in conjunction with accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of an electronic device according to an embodiment of the present disclosure.

FIG. 2 is a flowchart of a method for selecting multiple objects according to an embodiment of the present disclosure.

FIG. 3 is a schematic diagram of activating a first multiple objects selection function of a File Explorer application according to an embodiment of the present disclosure.

FIG. 4 is a schematic diagram of activating a first multiple objects selection function of a Microsoft Office Word application according to an embodiment of the present disclosure.

FIG. 5 is a schematic diagram of activating a first multiple objects selection function of a Microsoft Office Excel application according to an embodiment of the present disclosure.

FIG. 6 is a schematic diagram of activating a second multiple objects selection function of a Microsoft Office Excel application according to an embodiment of the present disclosure.

### DESCRIPTION OF THE EMBODIMENTS

In order to let the user of the electronic device having the touch screen uses the multiple objects selection function of the specific application in a more convenient manner, the embodiment of the present disclosure provides a method for selecting multiple objects. The provided method for selecting multiple objects is capable of identifying whether the application currently executed by the operating system (OS) belongs to the first type application or the second type application, so as to display the corresponding multi-selection button on the touch screen according to the identification result. Thereby, when the user is intended to activate the multiple objects selection function, the user may easily activate the corresponding multiple objects selection function in a rapid manner via the multi-selection button.

Further, the electronic device for implementing the method for selecting multiple objects is disclosed by the embodiment of the present disclosure. Reference will now be made in detail to the present preferred embodiments of the disclosure, examples of which are illustrated in the accompanying drawings. Wherever possible, the same reference numbers are used in the drawings and the description to refer to the same or like parts.

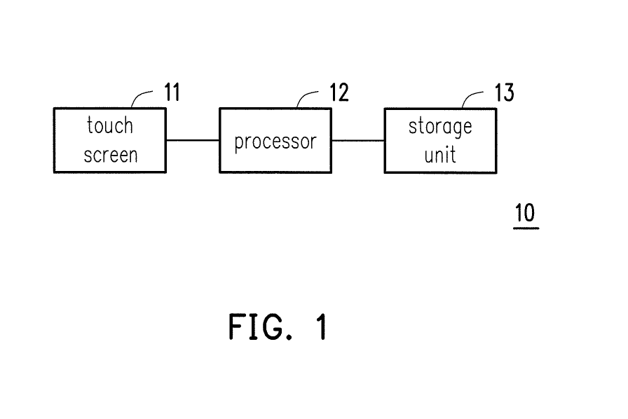

FIG. 1 is a diagram of an electronic device according to an embodiment of the present disclosure. Referring to FIG. 1, the electronic device 10 includes a touch screen 11, a processor 12 and a storage unit 13. The electronic device 10 can be a Personal Digital Assistant (PDA), a smart phone, an electronic book, a game machine or a tablet personal computer (Tablet PC), etc., which supports the touch-control and the display functions.

The touch screen 11 can be a resistive touch panel, a capacitive touch panel, an optical touch panel, an acoustic touch panel, an electromagnetic panel, etc., and it is not limited herein. The user executes the input operation or the select operation such as touching or dragging on the touch screen 11 via the input tools such as the stylus or fingers in order to input words or commands.

The processor 12 is coupled to the touch screen 11. In the present embodiment, the processor 12 can be a micro-controller, an embedded controller, a central processing unit (CPU), etc., and the processor 12 is not limited herein. The processor 12 executes an operating system (OS), and Microsoft Windows OS will be the exemplary OS described in the following description for demonstrating the embodiments. For instance, the OS can be a Windows XP, Windows Vista, Windows 7, Windows 8, etc., and the type of the OS is not limited herein.

The storage unit 13 is coupled to the processor 12. The storage unit 13, for example, is a Hard Disk Drive (HDD) or a non-volatile memory. Besides, the storage unit 13 also includes various external storage medium, such as a CD-ROM or a flash disk, and the type of the storage unit 13 used in the electronic device 10 is not limited herein. The storage unit 13 is configured to store various data, such as the OS operable by the processor 12 and the program code of the application.

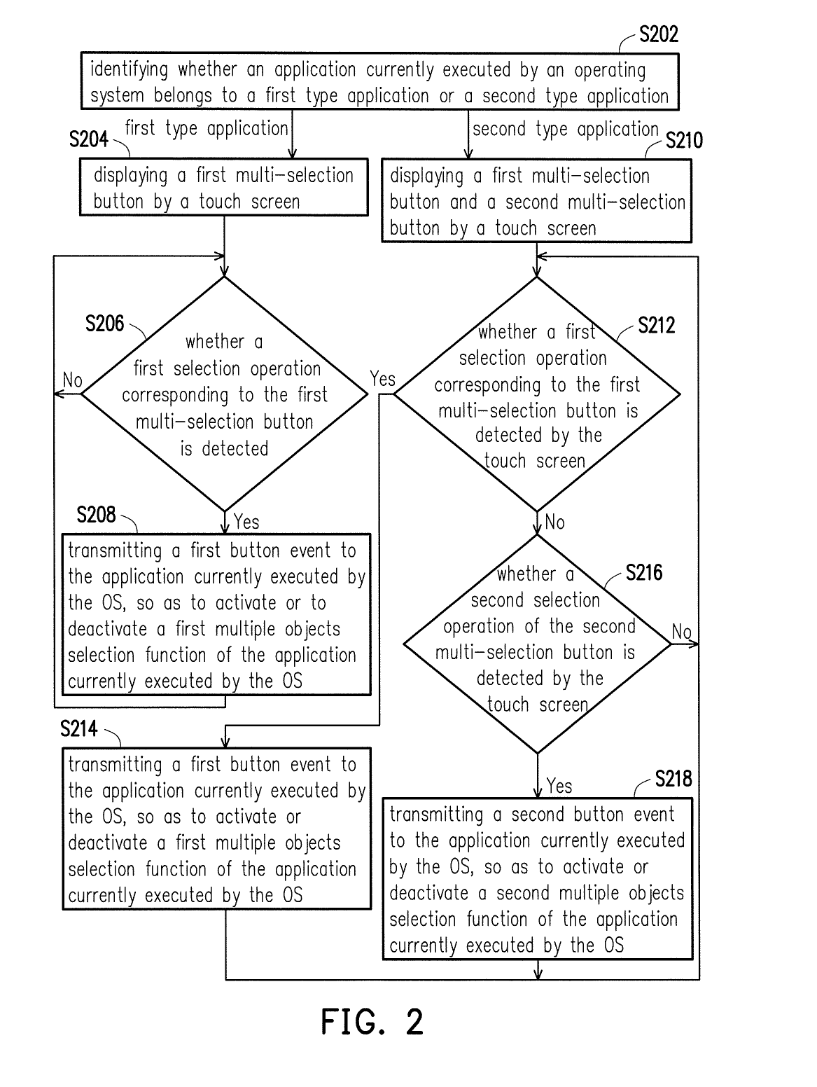

FIG. 2 is a flowchart of a method for selecting multiple objects according to an embodiment of the present disclosure. FIG. 2, in conjunction with the view of FIG. 1, is used as the reference for providing a detailed description to the method for selecting multiple objects and the electronic device 10 below.

Referring to FIGS. 1 and 2, in step S202, the processor 12 identifies whether the application currently executed by the OS (hereinafter as the target application) belongs to a first type application or a second type application. In the present embodiment, the first type application includes a desktop application, a File Explorer application, a Microsoft Office Word and a Microsoft Office Power Point of the Microsoft Office, etc., which supports the multiple objects selection function. Further, the second type application includes a Microsoft Office Excel of the Microsoft Office, which supports both the multiple objects selection function and the multiple storage cells selection function.

For instance, the processor 12 can take the application currently operating by the user via the touch screen 11 as the target application, and identifies whether the target application belongs to a first type application or a second type application. In the present embodiment, the processor 12 can identify whether the target application belongs to the first type application or the second type application by comparing the name, the attribute or the code of the applications. On the other hand, the processor 12 can only identify that whether the target application belongs to the second type application or not. If the target application does not belong to the second type application, then the processor 12 identifies that the target application belongs to the first type application. Further, the processor 12 can identify that whether the target application supports the first multiple objects selection function (for example, the multiple objects selection function) and/or the second multiple objects selection function (for example, the multiple storage cells selection function). If the target application only supports the first multiple objects selection function, then the processor 12 identifies that the target application belongs to the first type application. If the target application supports the first multiple objects selection function and the second multiple objects selection function, then the processor 12 identifies that the target application belongs to the second type application.

If the processor 12 identifies that the target application belongs to the first type application, then the processor 12 executes the step S204 after the step S202. If the processor 12 identifies that the target application belongs to the second type application, then the processor 12 executes the step S210 after the step S202.

However, if the processor 12 determines that the target application does not belong to the first type application and the second type application, the following steps of the method for selecting multiple objects will not be executed and the method for selecting multiple objects is thus terminated. Furthermore, in an embodiment, if the processor 12 determines that the target application does not belong to the first type application and the second type application, the processor 12 regards the target application as the first type application and executes the step S204 after the step S202. In other words, the method for determining the following step is not limited herein in the present disclosure.

It should be noted that, the step S202 is executed when the target application is activated by the OS, when a trigger button displayed on the touch screen 11 is selected by the user or when an application is switched from the background to be a currently operated application, and the timing for executing the step S202 can be varied according to actual/design requirements.

When the target application is identified to belong to the first type application, in the step S204, a first multi-selection button is displayed by the touch screen 11, in which the first multi-selection button is configured to generate a first button event when the first multi-selection button is triggered. In the present application, the first button event includes the button event which is generated at the time when the function button “Ctrl” of the standard keyboard is pressed. In the step S206, the processor 12 determines whether a first selection operation corresponding to the first multi-selection button is detected by the touch screen 12. In the present embodiment, the first selection operation, for example, is selecting the first multi-selection button on the touch screen 12 via fingers or a touch pen by the user. If the touch screen 11 does not detect the first selection operation corresponding to the first multi-selection button, then the step S206 is executed repeatedly.

When the first selection operation corresponding to the first multi-selection button is detected by the touch screen 11, in step S208, the processor 12 transmits the first button event to the target application, so as to activate or to deactivate the first multiple objects selection function of the target application. In the present embodiment, the first multiple objects selection function is the multiple objects selection function normally supported by applications such as the desktop application, the File Explorer application or the Microsoft Office (Microsoft Office Word, Excel and Power Point).

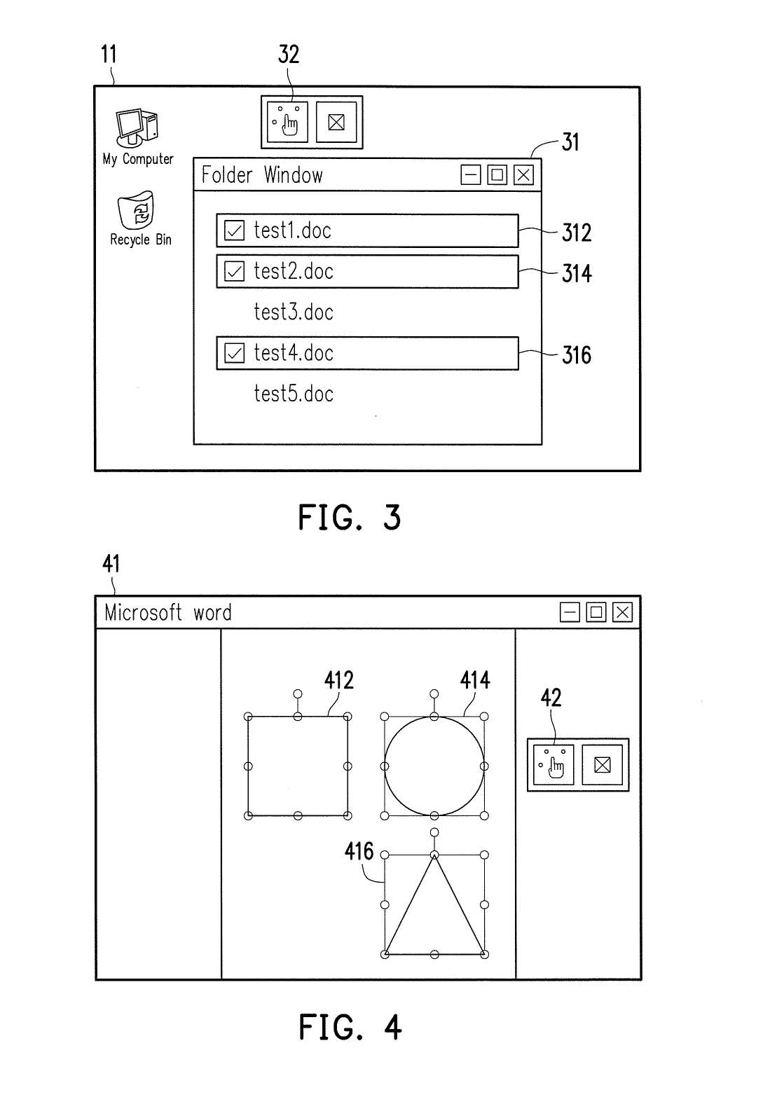

For instance, FIG. 3 is a schematic diagram of activating a first multiple objects selection function of a File Explorer application according to an embodiment of the present disclosure. Referring to FIG. 3 and taking the folder window 31 of the File Explorer application displayed by the touch screen 11 as the example, when the first multi-selection button 32 is selected by the user, the processor 12 transmits the first button event (such as the button event which is generated at the time when the function button “Ctrl” of the standard keyboard is pressed) to the File Explorer application. If the first multiple objects selection function of the File Explorer application has not been activated before the reception of the first button event, the File Explorer application will activate the first multiple objects selection function when receiving the first button event.

As illustrated in FIG. 3, after the first multiple objects selection function of the File Explorer application is activated by the File Explorer application, the user can execute the multiple objects selection operation. For example, the user is capable of selecting the file 312, the file 314 and the file 316 of the folder window 31 in once. On the other hand, if the first multiple objects selection function of the File Explorer application has been activated before the reception of the first button event, the File Explorer application will deactivate the first multiple objects selection function when receiving the first button event, so that the user can perform the operation such as copy, move or delete on the selected objects (for example, file 312, file 314 and file 316).

Another exemplary embodiment is provided below. FIG. 4 is a schematic diagram of activating a first multiple objects selection function of a Microsoft Office Word application according to an embodiment of the present disclosure. Referring to FIG. 4 and taking the Word document editing window 41 of the Microsoft Office Word application as the example, when the first multi-selection button 42 displayed by the touch screen is selected by the user, the processor 12 transmits the first button event (such as the button event which is generated at the time when the function button “Ctrl” of the standard keyboard is pressed) to the Microsoft Office Word application. If the first multiple objects selection function of the Microsoft Office Word application has not been activated before the reception of the first button event, the Microsoft Office Word application will activate the first multiple objects selection function when receiving the first button event.

As illustrated in FIG. 4, after the first multiple objects selection function of the Microsoft Office Word application is activated by the Microsoft Office Word application, the user can execute the multiple objects selection operation. For example, the user is capable of selecting the object 412, the object 414 and the object 416 of the Word document editing window 41 in once. On the other hand, if the first multiple objects selection function of the Microsoft Office Word application has been activated before the reception of the first button event, the Microsoft Office Word application will deactivate the first multiple objects selection function when receiving the first button event, so that the user can perform the operation such as copy, move or delete on the selected objects (for example, object 412, object 414 and object 416).

It should be noted that, the first multi-selection button 32 described above is displayed by the touch screen at the time where the folder window 31 is opened, where the folder window 31 is called from the background to the foreground for user operation or where the File Explorer application is executed, but the timing of displaying the first multi-selection button 32 is not limited herein. Similarly, the first multi-selection button 42 described above is displayed by the touch screen at the time where the Word document editing window 41 is opened, where the Word document editing window 41 is called from the background to the foreground for user operation or where the Microsoft Office Word application is executed, but the timing of displaying the first multi-selection button 42 is not limited herein.

Referring to FIGS. 1 and 2, after the step S208, the step S206 is executed repeatedly. From another aspect, when the target application is identified to belong to the second type application, in the step S210, the first multi-selection button and the second multi-selection button are displayed by the touch screen 11, where the first multi-selection button is configured to generate the first button event when the first multi-selection button is triggered (such as the button event which is generated at the time when the function button “Ctrl” of the standard keyboard is pressed), and the second multi-selection button is configured to generate the second button event when the second multi-selection button is triggered. In the present application, the second button event includes the button event which generated at the time when both of the function buttons “Shift” and “F8” of the standard keyboard are pressed simultaneously or sequentially. In the step S212, the processor 12 determines whether the first selection operation corresponding to the first multi-selection button is detected by the touch screen 11. When the first selection operation corresponding to the first multi-selection button is detected by the touch screen 11, in step S214, the processor 12 transmits the first button event to the target application, so as to activate or deactivate the first multiple objects selection function of the target application. The step S212 is similar to the step S206, and the step S214 is similar to the step S208, so the detailed description of those steps is omitted. After the step S214, the step S212 is repeatedly executed.

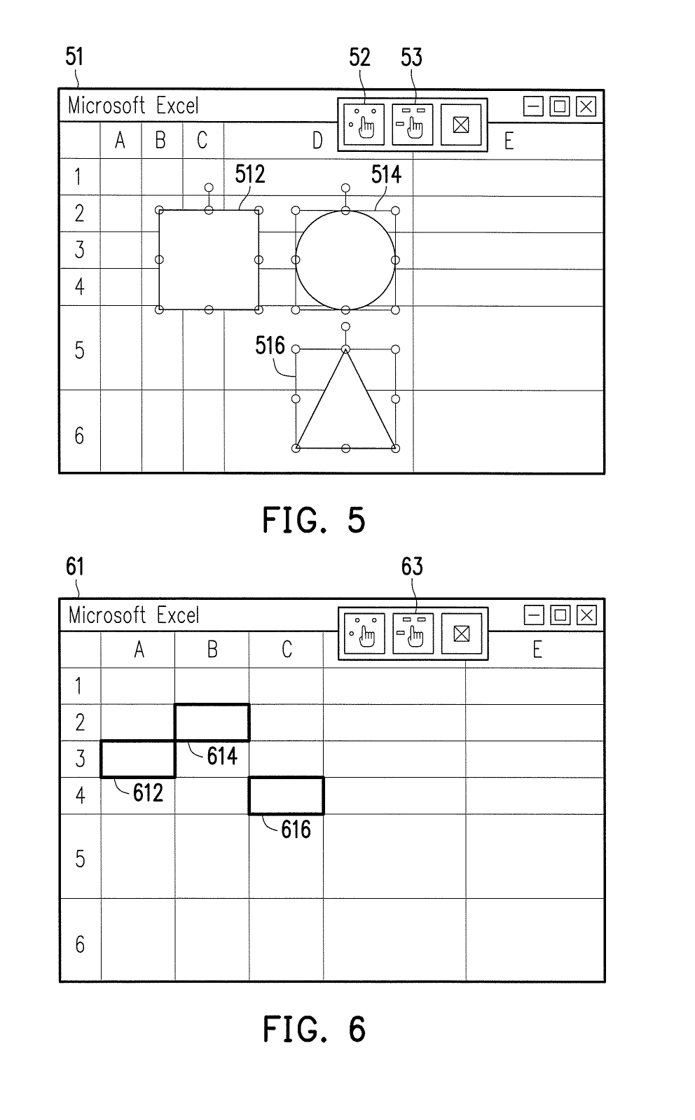

For instance, FIG. 5 is a schematic diagram of activating a first multiple objects selection function of a Microsoft Office Excel application according to an embodiment of the present disclosure. Referring to FIG. 5 and taking the Excel document editing window 51 of the Microsoft Office Excel application as the example, the first multi-selection button 52 and the second multi-selection button 53 are displayed by the touch screen. When the first multi-selection button 52 is selected by the user, the processor transmits the first button event (such as the button event which is generated at the time when the function button “Ctrl” of the standard keyboard is pressed) to the Microsoft Office Excel application. If the first multiple objects selection function of the Microsoft Office Excel application has not been activated before the reception of the first button event, the Microsoft Office Excel application will activate the first multiple objects selection function when receiving the first button event.

As illustrated in FIG. 5, after the first multiple objects selection function of the Microsoft Office Excel application is activated by the Microsoft Office Excel, the user can execute the multiple objects selection operation. For example, the user is capable of selecting the object 512, the object 514 and the object 516 of the Excel document editing window 51 in once. On the other hand, if the first multiple objects selection function of the Microsoft Office Excel application has been activated before the reception of the first button event, the Microsoft Office Excel application will deactivate the first multiple objects selection function when receiving the first button event, so that the user can perform the operation such as copy, move or delete on the selected objects (for example, object 512, object 514 and object 516).

In addition, if the first multiple objects selection function is not supported by the target application, the target application will not activate the first multiple objects selection function when receiving the first button event.

Referring to FIGS. 1 and 2 again, if the first selection operation corresponding to the first multi-selection button is not detected by the touch screen 11, then in the step S216, the processor 10 determines whether the second selection operation of the second multi-selection button is detected by the touch screen 11. In the present embodiment, the second selection operation, for example, is selecting the second multi-selection button on the touch screen 11 via the input tool such as fingers or a touch pen by the user. If the touch screen does not detect the second selection operation corresponding to the second multi-selection button, the step S212 will be executed repeatedly.

When the second selection operation corresponding to the second multi-selection button is detected by the touch screen 11, in the step S218, the processor 12 transmits the second button event to the target application, so as to activate or deactivate the second multiple objects selection function of the target application. In the present embodiment, the second multiple objects selection function is the multiple storage cells selection function supported by the Microsoft Office Excel application of the Microsoft Office.

For another example, FIG. 6 is a schematic diagram of activating a second multiple objects selection function of a Microsoft Office Excel application according to an embodiment of the present disclosure. Referring to FIG. 6 and taking the Excel document editing window 61 of the Microsoft Office Excel application as the example, when the second multi-selection button 63 displayed by the touch screen is selected by the user, the processor transmits the second button event (such as the button event which is generated at the time when both of the function buttons “Shift” and “F8” of the standard keyboard are pressed simultaneously or sequentially) to the Microsoft Office Excel application. If the second multiple objects selection function of the Microsoft Office Excel application has not been activated before the reception of the second button event, the Microsoft Office Excel application will activate the second multiple objects selection function when receiving the second button event.

As illustrated in FIG. 6, after the second multiple objects selection function of the Microsoft Office Excel application is activated by the Microsoft Office Excel application, the user can execute the multiple storage cells selection operation. For example, the user is capable of selecting the storage cell 612, the storage cell 614 and the storage cell 616 of the Excel document editing window 61 in once. On the other hand, if the second multiple objects selection function of the Microsoft Office Excel application has been activated before the reception of the second button event, the Microsoft Office Excel application will deactivate the second multiple objects selection function when receiving the second button event, so that the user can perform the operation such as copy, move, delete or statistical calculation according to the selected storage cell (for example, storage cell 512, storage cell 514 and storage cell 516).

It should be noted that, the first multi-selection button and the second selection button mentioned in the present embodiment are adaptively switched to display on the touch screen according to the different target applications. That is to say, the first multi-selection button and the second multi-selection button do not belong to the on-screen keyboard applications of the various operating systems. In other words, the first multi-selection button and the second multi-selection button are independently executed from the on-screen keyboard application.

Moreover, the first button event and the second button event mentioned above can be stored preliminarily in the storage unit of the electronic device (such as the storage unit 13 shown in FIG. 1). When the first selection operation corresponding to the first multi-selection button or the second selection operation corresponding to the second multi-selection button is detected by the touch screen 13, the processor 13 reads the first button event or the second button event from the storage unit (such as the storage unit 13 shown in FIG. 1), and transmits the first button event or the second button event to the target application.

As described above, the method for selecting multiple objects and the electronic device provided in the present disclosure determine whether to display the specific one or more multi-selection buttons on the touch screen according to the application executed by the OS. In addition, when detecting that one of the multi-selection buttons is selected by the user on the touch screen, the present disclosure applies the button event corresponding to the selected multi-selection button to activate or deactivate the multiple objects selection function or the multiple storage cells selection function of the application currently executed by the OS, so as to reach the achievement of simplifying the procedure of activating or deactivating the multiple objects selection function or the multiple storage cells selection function of the application.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for selecting multiple objects, applicable to an electronic device, the electronic device comprises a touch screen and a processor, and the processor executes an operating system (OS), the method for selecting multiple objects comprising:
identifying whether an application currently executed by the OS belongs to a first type application or a second type application;
when the application currently executed by the OS is identified to belong to the first type application, displaying a first multi-selection button by the touch screen, wherein the first multi-selection button is configured to generate a first button event when the first multi-selection button is triggered; and
when the first button event is detected by the touch screen, activating or deactivating a first multiple objects selection function of the application which is currently executed by the OS.

2. The method for selecting multiple objects according to claim 1, wherein the first multi-selection button does not belong to an on-screen keyboard application.

3. The method for selecting multiple objects according to claim 1, further comprises:
when the application currently executed by the OS is identified to belong to the second type application, displaying the first multi-selection button and a second multi-selection button by the touch screen, wherein the second multi-selection button is configured to generate a second button event when the second multi-selection button is triggered, and the second button event is different from the first button event; and
when the second button event is detected by the touch screen, activating or deactivating a second multiple objects selection function of the application which is currently executed by the OS.

4. The method for selecting multiple objects according to claim 3, wherein the second multi-selection button does not belong to an on-screen keyboard application.

5. The method for selecting multiple objects according to claim 1, wherein the application currently executed by the OS is an application currently operated by an user via the touch screen.

6. An electronic device, comprising:
a touch screen; and
a processor, coupled to the touch screen, and executes an operating system (OS),
wherein the processor identifies whether an application currently executed by the OS belongs to a first type application or a second type application;
when the application currently executed by the OS is identified to belong to the first type application, a first multi-selection button is displayed by the touch screen, wherein the first multi-selection button is configured to generate a first button event when the first multi-selection button is triggered,
when the first button event is detected by the touch screen, a first multiple objects selection function of the application which is currently executed by the OS is activated or deactivated.

7. The electronic device according to claim 6, wherein the first multi-selection button does not belong to an on-screen keyboard application.

8. The electronic device according to claim 6, wherein when the application currently executed by the OS is identified to belong to the second type application, the first multi-selection button and a second multi-selection button are displayed by the touch screen, wherein the second multi-selection button is configured to generate a second button event when the second multi-selection button is triggered,
when the second touch event is detected by the touch screen, a second multiple objects selection function of the application which is currently executed by the OS is activated or deactivated.

9. The electronic device according to claim 8, wherein the second multi-selection button does not belong to an on-screen keyboard application.

10. The electronic device according to claim 6, wherein the application currently executed by the OS is an application currently operated by an user via the touch screen.
